(19) United States
(12) Patent Application Publication
(10) Pub. No.: US 2017/0371645 A1
(43) Pub. Date: Dec. 28, 2017

(54) INFORMATION PROCESSING APPARATUS, OPERATION UPDATE METHOD AND OPERATION UPDATE PROGRAM

(71) Applicant: KONICA MINOLTA, INC., Tokyo (JP)

(72) Inventor: Hirotsugu HIRAMOTO, Kobe-shi (JP)

(73) Assignee: KONICA MINOLTA, INC., Tokyo (JP)

(21) Appl. No.: 15/636,068

(22) Filed: Jun. 28, 2017

(30) Foreign Application Priority Data
Jun. 28, 2016 (JP) 2016-127545

(51) Int. Cl. G06F 9/445; G06F 9/44; H04N 1/00

(52) U.S. Cl. CPC G06F 8/67; H04N 1/00938; G06F 8/71; H04N 1/00973; G06F 9/4411; H04N 2201/0094

(57) ABSTRACT

An information processing apparatus includes: an external apparatus control unit controlling an external apparatus in accordance with data output from a task executing a processing program defining processing for outputting data to be processed by the external apparatus; and a determination unit determining whether a version of the processing program is newer than a known version, wherein in a case where the version of the processing program is determined to be the same as the known version, the external apparatus control unit executes processing defined in advance for the known version, and in a case where the version of the processing program is determined to be newer than the known version, the external apparatus control unit executes processing defined in advance for the unknown version.

The entire disclosure of Japanese Patent Application No. 2016-127545 filed on Jun. 28, 2016 including description, claims, drawings, and abstract are incorporated herein by reference in its entirety.

### BACKGROUND OF THE INVENTION

### Field of the Invention

This invention relates to an information processing apparatus, an operation update method, and an operation update program, and more particularly, this invention relates to an information processing apparatus capable of controlling operation of an external apparatus, and relates to an operation update method and an operation update program executed on the information processing apparatus.

### Description of the Related Art

In an information processing apparatus such as a personal computer (hereinafter referred to as “PC”), a printer driver program is installed in order to control an external apparatus such as a multifunction peripheral (hereinafter referred to as “MFP”). Hereinafter, the task in which the CPU of the information processing apparatus executes the printer driver program is simply referred to as a “printer driver”.

In the information processing apparatus, an operation system program (hereinafter referred to as an “OS program”) or an application program is installed. The printer driver controls the MFP in accordance with the output of the task in which the CPU of the information processing apparatus executes the application program or the task in which the CPU of the information processing apparatus executes the OS program.

By the way, depending on the version of OS program or application program, the operation of the printer driver may be different. Therefore, when the version of the OS program or the application program is updated, it is necessary to cause the printer driver to operate with the new version.

When the information processing apparatus is connected to the Internet, it is possible to acquire update information for automatically updating the operation of the printer driver from an external server via the Internet. However, communication between the information processing apparatus and the outside may be blocked because of security reasons, or automatic updating of programs installed in the information processing apparatus may be prohibited. In such a case, even if the version of the OS program or the application program is updated, the operation of the printer driver cannot be automatically updated.

For example, JP 2000-222146A describes a print data conversion apparatus switching drawing performance of print data in accordance with predetermined information about a print request and an application program generating print data in the print request on the basis of a predetermined operation and converting the print data on the basis of the drawing performance, and the print data conversion apparatus includes information obtaining means obtaining the predetermined information when receiving the print request, drawing performance switching means switching the drawing performance of the print data on the basis of the predetermined information obtained by the information obtaining means, print data conversion means receiving the print data and converting a data format of the print data on the basis of the drawing performance switched by the drawing performance switching means, and print data output means outputting the print data converted by the print data conversion means.

However, in the print data conversion apparatus described in JP 2000-222146 A, an association table indicating association between type and version information about the application program and drawing performance is prepared in advance, and the drawing performance of the print data is switched by referring to the association table. Therefore, in a case where the association table does not include the type and the version information about the used application program, the drawing performance of the print data cannot be switched. Therefore, in a case where an application program of an unknown version is used, an external apparatus such as an MET and the like cannot be appropriately controlled.

### SUMMARY OF THE INVENTION

This invention has been made to solve the above problems, and it is an object of this invention to provide an information processing apparatus capable of controlling an external apparatus in association with update of a processing program.

It is another object of this invention to provide an operation update method capable of controlling an external apparatus in association with update of a processing program.

It is still another object of this invention to provide an operation update program capable of controlling an external apparatus in association with update of a processing program.

To achieve at least one of the abovementioned objects, according to an aspect, an information processing apparatus reflecting one aspect of the present invention comprises: an external apparatus control unit controlling an external apparatus in accordance with data output from a task executing a processing program defining processing for outputting data to be processed by the external apparatus; and a determination unit determining whether a version of the processing program is newer than a known version, wherein in a case where the version of the processing program is determined to be the same as the known version, the external apparatus control unit executes processing defined in advance for the known version, and in a case where the version of the processing program is determined to be newer than the known version, the external apparatus control unit executes processing defined in advance for the unknown version.

According to this aspect, in a case where the version of the processing program is the same as a known version, processing defined in advance for the known version is executed, and in a case where the version of the processing program is newer than the known version, processing defined in advance for an unknown version is executed. Therefore, even in a case where update information cannot be obtained from an external server, processing corresponding to the unknown version can be executed. As a result, the information processing apparatus capable of controlling an external apparatus in association with update of a processing program can be provided.

The information processing apparatus preferably further comprises an identification information obtaining unit obtaining identification information identifying the version of the processing program, wherein the determination unit preferably determines whether the version indicated by the obtained identification information is newer than the known version.

According to this aspect, a determination can be appropriately made as to whether the version of the processing program is newer than the known version.

The identification information preferably includes a version number corresponding to the version, and the determination unit preferably determines whether the version number included in the identification information obtained is higher than a version number corresponding to the known version.

According to this aspect, a determination can be easily made as to whether the version of the processing program is newer than the known version.

The identification information preferably includes a release date of the version of the processing program, and the determination unit preferably determines whether the release date included in the identification information is later than the release date of the known version.

According to this aspect, a determination can be easily made as to whether the version of the processing program is newer than the known version.

The determination unit preferably determines whether a format of data output from a task executing the processing program is a format defined in advance.

According to this aspect, a determination can be made as to whether the version of the processing program is changed.

The determination unit preferably determines whether a command output from a task executing the processing program is a command defined in advance.

According to this aspect, a determination can be made as to whether the version of the processing program is changed.

The information processing apparatus preferably further comprises a table storage unit storing an association table associating one or more known versions of the processing program and processing supporting the known versions, wherein the determination unit preferably determines whether the version of the processing program is newer than the version included in the association table.

According to this aspect, a determination as to whether the version of the processing program is newer than the known version can be easily made by referring to the association table. In a case where the version of the processing program is a known version, processing corresponding to the known version can be easily identified by referring to the association table.

The determination unit preferably includes: an inquiry unit asking a user of an inquiry as to whether the version of the processing program is newer than the known version; and an answer reception unit receiving an answer in reply to the inquiry.

According to this aspect, whether a version is new is determined in accordance with an answer of a user, and therefore, a determination as to whether the version of the processing program is newer than the known version can be reliably made.

The information processing apparatus preferably further comprises an update command unit commanding the external apparatus to perform update in order to cause the external apparatus to support the unknown version in a case where the version of the processing program is determined to be newer than the known version.

According to this aspect, the external apparatus can be associated with the changed processing program.

To achieve at least one of the abovementioned objects, according to an aspect, there is provided an operation update method executed by an information processing apparatus including an external apparatus control unit controlling an external apparatus in accordance with data output from a task executing a processing program defining processing for outputting data to be processed by the external apparatus, and the method reflecting one aspect of the present invention comprises: a determination step of determining whether a version of the processing program is newer than a known version; and a processing execution step of causing the external apparatus control unit to execute processing defined in advance for the known version in a case where the version of the processing program is determined to be the same as the known version, and causing the external apparatus control unit to execute processing defined in advance for the unknown version in a case where the version of the processing program is determined to be newer than the known version.

According to this aspect, an operation update method capable of controlling an external apparatus in association with update of a processing program can be provided.

To achieve at least one of the abovementioned objects, according to an aspect, there is provided a non-transitory recording medium storing a computer readable operation update program executed by a computer controlling an information processing apparatus including an external apparatus control unit controlling an external apparatus in accordance with data output from a task executing a processing program defining processing for outputting data to be processed by the external apparatus, and the program reflecting one aspect of the present invention causes the computer to execute: a determination step of determining whether a version of the processing program is newer than a known version; and a processing execution step of causing the external apparatus control unit to execute processing defined in advance for the known version in a case where the version of the processing program is determined to be the same as the known version, and causing the external apparatus control unit to execute processing defined in advance for the unknown version in a case where the version of the processing program is determined to be newer than the known version.

According to this aspect, an operation update program capable of controlling an external apparatus in association with update of a processing program can be provided.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an example of an overview of an entire a print system according to one of first embodiments of the present invention;

FIG. 2 is a block diagram showing an example of an outline of a hardware configuration of a PC according to the present embodiment;

FIG. 3 is a block diagram showing an overview of a hardware configuration of an MFP according to the present embodiment;

FIG. 4 is a block diagram showing an example of the functions of the CPU of the PC and information stored in the HDD;

FIG. 5 is a figure showing an example of an association table;

FIG. 6 is a flowchart showing an example of a flow of operation update processing according to the first embodiment;

FIG. 7 is a flowchart showing an example of a flow of operation update processing according to a first modification;

FIG. 8 is a block diagram showing an example of the functions of a CPU of a PC according to a second modification;

FIG. 9 is a flowchart showing an example of a flow of operation update processing according to the second modification;

FIG. 10 is a block diagram showing an example of the functions of a CPU of a PC according to a second embodiment;

FIG. 11 is a flowchart showing an example of a flow of operation update processing according to the second embodiment;

FIG. 12 is a block diagram showing an example of the functions of a CPU of a PC according to a third embodiment;

FIG. 13 is a flowchart showing an example of a flow of operation update processing according to the third embodiment;

FIG. 14 is a block diagram showing an example of the functions of a CPU of a PC according to a fourth embodiment; and

FIG. 15 is a flowchart showing an example of a flow of operation update processing according to the fourth embodiment.

### DESCRIPTION OF THE PREFERRED EMBODIMENTS

Hereinafter, an embodiment of the present invention will be described with reference to the drawings. However, the scope of the invention is not limited to the illustrated examples. In the following description, the same components are denoted with the same reference numerals. The names and functions thereof are also the same. Therefore, a detailed description thereabout will not be repeated.

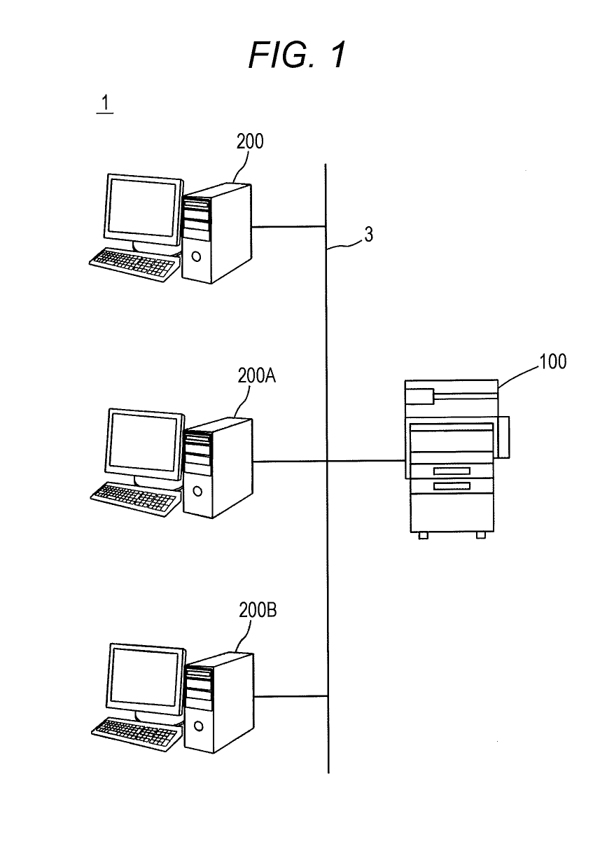

FIG. 1 shows an example of an overview of an entire print system according to one of first embodiments of the present invention. As shown in FIG. 1, a print system 1 includes an MFP (Multi Function Peripheral) 100 which is a Multi Function Peripheral, and personal computers (PCs) 200, 200A, and 200B. The MFP 100 and the PCs 200, 200A, and 200B are connected to a local area network (LAN) 3. Hereinafter, the PCs 200, 200A, and 200B may be collectively referred to as PCs 200.

The PCs 200, 200A, and 200B are generally-available computers, and the operating system (OS) program and the application programs are installed on the PCs 200, 200A, and 200B. In the PCs 200, 200A, and 200B, an operation system program (hereinafter referred to as “OS program”) is installed, and a printer driver program for controlling the MFP 100 is installed. In this example, the OS program is an example of a processing program. The PCs 200, 200A, and 200B execute different processing for the MFP 100 according to the current version of the OS program.

The hardware configurations and the functions of the PCs 200, 200A, and 200B are the same, and in this case, this will be explained with reference to an example of a PC 200. As long as connectable to the LAN 3 just like the PCs 200, 200A, and 200B, a portable information apparatus carried and used by a user such as a smartphone, a tablet device, a PDA (Personal Digital Assistants), or the like may be used instead of the PCs 200, 200A, and 200B.

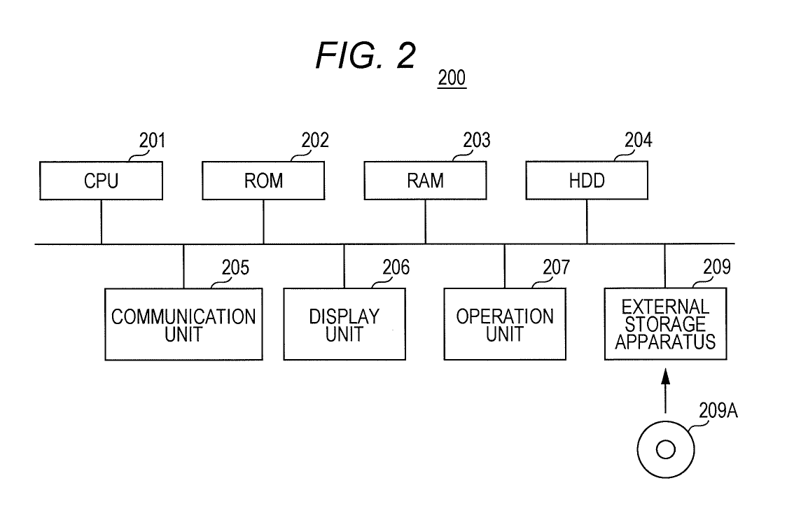

FIG. 2 is a block diagram showing an example of an outline of a hardware configuration of a PC according to the present embodiment. As shown in FIG. 2, the PC 200 includes a central processing unit (CPU) 201 controlling the entire PC 200, a ROM (Read Only Memory) 202 storing a program executed by the CPU 201, a RAM (Random Access Memory) 203 used as a work area of the CPU 201, a hard disk drive (HDD) 204 storing data in a non-volatile manner, a communication unit 205 for connecting the CPU 201 to the LAN 3, a display unit 206 for displaying information, an operation unit 207 for receiving input of operation performed by the user, and an external storage apparatus 209.

A program is downloaded from a computer connected to the Internet into the HDD 204, or a computer connected to the network writes the program to the HDD 204, whereby the CPU 201 loads the program stored in the HDD 204 to the RAM 203, and executes the program. The HDD 204 stores the OS program and the application programs. The HDD 204 stores an association table associating one or more known versions of the OS program and pieces of processing corresponding to the known versions. The details of the association table will be described later.

In the software architecture of the CPU 201, CPU 201 is formed with an operating system (OS) layer and is formed with an application layer above the operating system (OS) layer. A task in which the CPU 201 executes the OS program belongs to the OS layer. The task which belongs to the OS layer executes processing for controlling hardware resource of the PC 200. In this case, the hardware resource includes a ROM 202, a RAM 203, an HDD 204, a communication unit 205, a display unit 206, an operation unit 207, and an external storage apparatus 209. The task which belongs to the OS layer controls the hardware resource according to an operating command input from the application layer. The task in which the CPU 201 executes the application program belongs to the application layer. In a case where multiple types of application programs are installed in the PC 200, multiple tasks executing multiple types of application programs may belong to the application layer. Furthermore, the task executing the application program specifies the processing to be executed from among multiple types of processing defined by the application program on the basis of the command given by the operation user who operates the PC 200, and executes the processing. The multiple types of processing defined by the application program include at least processing for causing the MFP 100 to print data generated when the CPU 201 executes the application program.

A CD-ROM (Compact Disk Read Only Memory) 209A is loaded to the external storage apparatus 209, CD-ROM (Compact Disk Read Only Memory) 209A. In the explanation about the present embodiment, for example, the CPU 201 executes a program stored in the ROM 202 or the HDD 204, but the CPU 201 may control the external storage apparatus 209 to read the program to be executed by the CPU 201 from the CD-ROM 209A, store the read program in the RAM 203, and execute the program.

The recording medium for storing the program to be executed by the CPU 201 is not limited to the CD-ROM 209A, and may be media such as a flexible disc, a cassette tape, optical discs (MO (Magnetic Optical Disc), MD (Mini Disc), DVD (Digital Versatile Disc)), an IC card, an optical card, and semiconductor memories such as a mask ROM, an EPROM (Erasable Programmable ROM), and an EEPROM (Electrically EPROM). The program referred to herein includes not only the program directly executable by the CPU 201 but also a source program, a compressed program, an encrypted program, and the like.

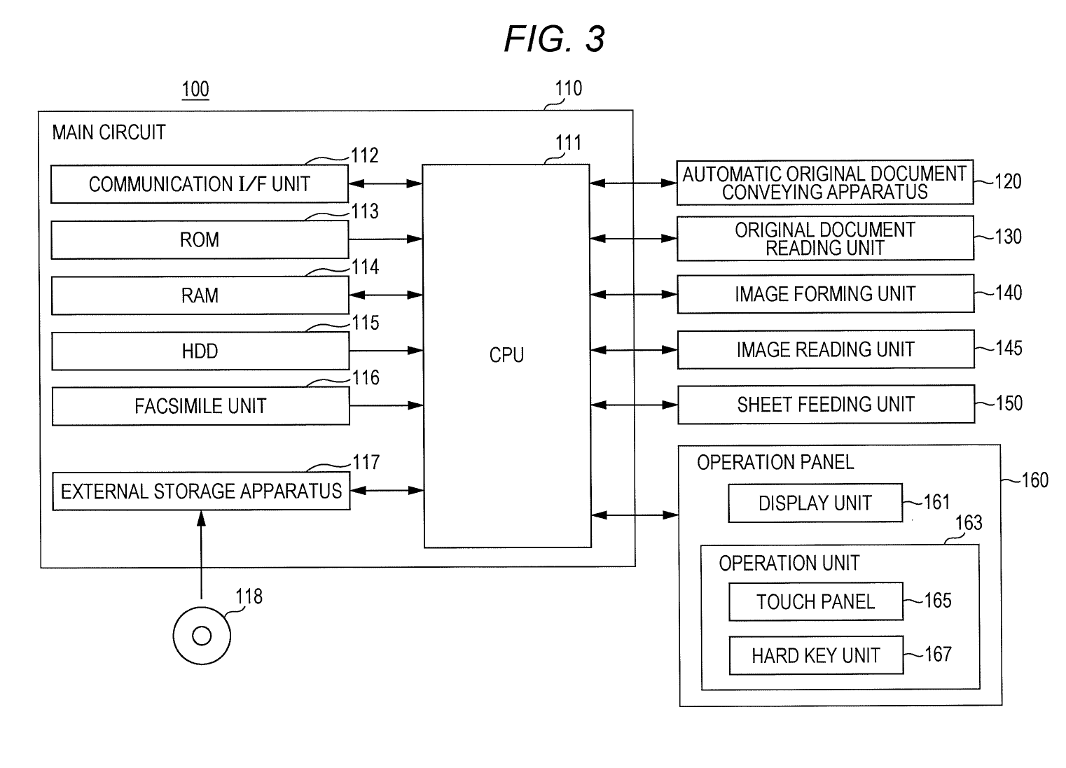

FIG. 3 is a block diagram showing an overview of a hardware configuration of the MFP 100 according to the present embodiment. As shown in FIG. 3, the MFP 100 functioning as the image processing apparatus includes a main circuit 110, an original document reading unit 130 reading original documents, an automatic original document conveying apparatus 120 for conveying an original document to the original document reading unit 130, an image forming unit 140 for forming an image on a sheet and the like on the basis of image data that is output from the original document reading unit 130 reading an original document, a sheet feeding unit 150 for supplying a sheet to the image forming unit 140, and an operation panel 160 serving as a user interface.

The automatic original document conveying apparatus 120 automatically conveys, one by one, multiple original documents, which are set on an original document tray, to a predetermined original document reading position that is defined on platen glass of the original document reading unit 130, and discharges the original document, from which the original document reading unit 130 reads the image formed on the original document, to an original document discharge tray. The original document reading unit 130 includes a light source emitting light to the original document conveyed to the original document reading position and a photoelectric conversion device receiving the light reflected by the original document, and scans the original document image according to the size of the original document. The photoelectric conversion device converts the received light into image data which is an electric signal and outputs the image data to the image forming unit 140. The sheet feeding unit 150 conveys the sheet stored in the sheet feeding tray to the image forming unit 140.

The image forming unit 140 forms an image according to a well-known electrophotographic method, and forms an image on a sheet conveyed by the sheet feeding unit 150 on the basis of externally received image data or image data processed in data processing in which various kinds of data processing such as shading correction are performed on the image data input from the original document reading unit 130, and discharges the sheet having the image formed thereon to the discharge tray.

The main circuit 110 includes a CPU 111 for controlling the entire MET 100, a communication interface (I/F) unit 112, a ROM 113, a RAM 114, a hard disk drive (HDD) 115 serving as a large capacity storage apparatus, a facsimile unit 116, and an external storage apparatus 117. The CPU 111 is connected to the automatic original document conveying apparatus 120, the original document reading unit 130, the image forming unit 140, the sheet feeding unit 150, and the operation panel 160, and controls the entire MFP 100.

The facsimile unit 116 is connected to a public switched telephone network (PSTN) and transmits facsimile data to the PSTN or receives facsimile data from the PSTN. The facsimile unit 116 stores the received facsimile data in the HDD 115, converts the facsimile data into print data that can be printed by the image forming unit 140, and outputs the print data to the image forming unit 140. As a result, the image forming unit 140 forms the image of the facsimile data received from the facsimile unit 116 on the sheet. In addition, the facsimile unit 116 converts the data stored in the HDD 115 into facsimile data and transmits the facsimile data to a facsimile apparatus connected to the PSTN.

The communication I/F unit 112 is an interface for connecting the MFP 100 to the LAN 3. The communication I/F unit 112 communicates with another computer or data processing apparatus connected to the network in accordance with a communication protocol such as TCP (Transmission Control Protocol) or FTP (File Transfer Protocol). It should be noted that the network to which the communication I/F unit 112 is connected is not limited to the LAN 3, and may be a wide area network (WAN), a public switched telephone network (PSTN), the Internet, or the like.

The ROM 113 stores a program executed by the CPU 111 or data necessary for executing the program. The RAM 114 is used as a work area when the CPU 111 executes the program. The RAM 114 temporarily stores the read image successively sent from the original document reading unit 130.

The operation panel 160 is provided on the upper surface of the MFP 100. The operation panel 160 includes a display unit 161 and an operation unit 163. The display unit 161 is, for example, a liquid crystal display apparatus (LCD), and the display unit 161 displays information about command menu for users and information about the acquired image data. It should be noted that instead of the LCD, for example, an organic EL (electroluminescence) display can be used as long as it is an apparatus displaying an image.

The operation unit 163 includes a touch panel 165 and a hard key unit 167. The touch panel 165 is a capacitance type. It should be noted that the touch panel 165 is not limited to the capacitive type, but other methods such as, for example, resistive film method, surface acoustic wave method, infrared method, electromagnetic induction method, and the like can be used for the touch panel 165. The hard key unit 167 includes a plurality of hard keys. The hard key is, for example, a contact switch.

The external storage apparatus 117 is controlled by the CPU 111, and the CD-ROM 118 is loaded to the external storage apparatus 117. In the present embodiment, for example, the CPU 111 executes the program stored in the ROM 113, but the CPU 111 may control the external storage apparatus 117 to read the program to be executed by the CPU 111 from the CD-ROM 118, store the read program in the RAM 114, and execute the program.

It should be noted that the recording medium for storing the program to be executed by the CPU 111 is not limited to the CD-ROM 118, and may be media such as a flexible disk, a cassette tape, an optical disk, an IC card, an optical card, and a semiconductor memory. Furthermore, the CPU 111 may download a program from a computer connected to the network and store the program in the HDD 115, or the computer connected to the network may write the program to the HDD 115, so that the program stored in the HDD 115 is loaded to the RAM 114 to be executed by the CPU 111. The program referred to herein includes not only the program directly executable by the CPU 111 but also a source program, a compressed program, an encrypted program, and the like.

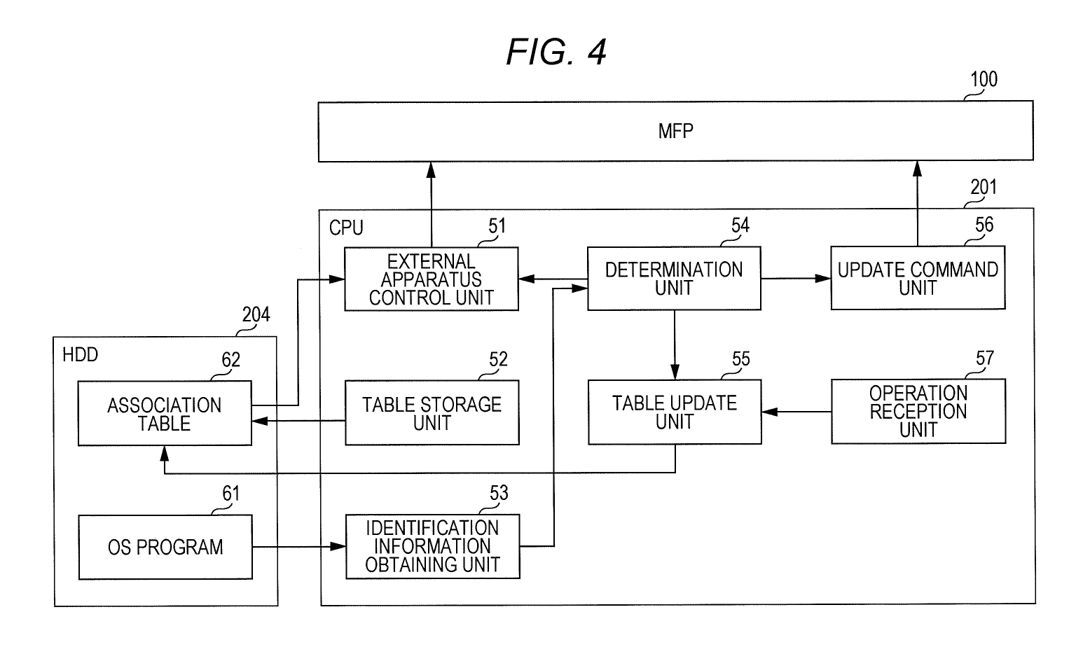

FIG. 4 is a block diagram showing an example of the functions of the CPU of the PC and information stored in the HDD. In this case, FIG. 4 shows the functions of the CPU 201 provided in the PC 200. The functions shown in FIG. 4 may be realized with hardware, or may be realized with the CPU 201 by causing the CPU 201 of the PC 200 to execute the program stored in the ROM 202, the HDD 204, or the CD-ROM 209A. In the following explanation, for example, the CPU 201 of the PC 200 is caused to execute the program.

As shown in FIG. 4, the CPU 201 of the PC 200 includes an external apparatus control unit 51, a table storage unit 52, an identification information obtaining unit 53, a determination unit 54, a table update unit 55, an update command unit 56, and an operation reception unit 57.

The external apparatus control unit 51 corresponds to the printer driver, and controls the MFP 100 according to the data output from the task which belongs to the OS layer or the application layer. In this case, the external apparatus control unit 51 operates in a selected operation mode selected from among a plurality of predetermined operation modes. The plurality of operation modes include a known operation mode supporting a known version of the OS program 61 and a temporary operation mode supporting an unknown version of the OS program 61. The known version is a version that has already been published, and a version number and the like are recognized in the PC 200. Programs or data which the CPU 201 executes processing corresponding to the operation content of the known operation mode as well as the association table 62 are stored in the HDD 204 in association with the known operation mode. The unknown version is a newer version than the known version, and the version number and the like are not recognized by the PC 200. The operation content of the temporary operation mode is notified in advance from the supplier of the OS program 61 in preparation for the release of the new version of the OS program 61. For this reason, programs or data which the CPU 201 executes processing corresponding to the operation content of the temporary operation mode are stored in the HDD 204 in association with the temporary operation mode.

The operation content of the printer driver is, for example, a format or command of data to be transmitted to the MFP 100, a user interface (UI) screen to be displayed on the display unit 206, a type of a communication route for printing structured with the MFP 100, a position of reference data, and the like. The operation content is determined for each known operation mode and temporary operation mode. The position of the reference data includes, for example, a storage location of a search result according to WSD (Web Services on Devices) protocol. When searching for devices on the network using a WSD port, the IP address of the detected device is stored in the location specified by the OS program 61. When the version of the OS program 61 is different, the storage location of the IP address may be different. Therefore, the storage location of the IP address to be referenced is specified for each operation mode.

The table storage unit 52 stores in the HDD 204 an association table 62 associating one or more known versions of the OS program 61 with the operation modes supporting the known versions. The association table 62 associates at least a version number corresponding to the known version and an operation mode supporting the known version. The association table 62 includes an association record for each version number, and the association record associates a version number corresponding to a known version, a release date of the known version, and an operation mode supporting the known version. Hereinafter, the version number and the operation mode supporting the known version will be referred to as a known version number and a known operation mode, respectively. The known version included in the association table 62 includes a known version defined as a default and a known version added by the table update unit 55 to be described later.

The identification information obtaining unit 53 obtains identification information for identifying the current version of the OS program 61 stored in the HDD 204 and outputs the identification information to the determination unit 54. The current version is a version installed in the PC 200, and the CPU 201 executes the OS program 61 of the current version. The identification information obtaining unit 53 obtains the identification information of the current version of the OS program 61 from the task in which the CPU 201 executes the OS program 61. The identification information includes, for example, the version number corresponding to the current version and the release date of the current version.

The determination unit 54 receives the identification information from the identification information obtaining unit 53. The determination unit 54 determines whether the current version of the OS program 61 is newer than the known version on the basis of the identification information. In this case, the determination unit 54 determines that the current version of the OS program 61 is a known version in a case where an association record including a version number corresponding to the current version included in the identification information is included in the association table 62. In a case where the current version of OS program 61 is a known version, the determination unit 54 outputs known version identification information for identifying the known version to the external apparatus control unit 51. In this case, the known version identification information is a version number included in the identification information.

In a case where an association record including a version number corresponding to the current version included in the identification information is not included in the association table 62, the determination unit 54 determines whether the version number corresponding to the current version is larger than the known version number. More specifically, the determination unit 54 refers to the association table 62 stored in the HDD 204 to determine whether the version number included in the identification information is larger than the highest version number of the known version numbers defined by the association records included in the association table 62. In a case where an association record including a version number corresponding to the current version included in the identification information is not included in the association table 62 and the version number included in the identification information is lower than the highest version number of the known version numbers defined by the association records included in the association table 62, the determination unit 54 determines that the current version of OS program 61 is a known version, and outputs the known version identification information for identifying the known version to the external apparatus control unit 51. In this case, the known version identification information is the highest version number of the known version numbers defined by the association records included in the association table 62.

In a case where an association record including a version number corresponding to the current version included in the identification information is not included in the association table 62, and the version number included in the identification information is higher than the highest version number of the known version numbers defined by the association records included in the association table 62, the determination unit 54 determines that the current version of the OS program 61 is newer than the known version. In a case where the current version of OS program 61 is newer than the known version, the determination unit 54 outputs an update command to the external apparatus control unit 51, the update command unit 56, and the table update unit 55. The update command includes a version number for identifying the current version.

The external apparatus control unit 51 operates in the known operation mode in accordance with input of known version identification information from the determination unit 54. More specifically, the external apparatus control unit 51 refers to the association table 62 to identify the operation mode supporting the version number which is the known version identification information, and operates in the identified operation mode. The external apparatus control unit 51 operates in the temporary operation mode in accordance with input of an update command from the determination unit 54.

In a case where the table update unit 55 receives the update command from the determination unit 54, the table update unit 55 associates a version number corresponding to an unknown version and an operation mode supporting the version. More specifically, the table update unit 55 generates an association record including the version number included in the update command and the temporary operation mode stored in the HDD 204 in accordance with input of the update command from the determination unit 54, and adds the association record to the association table 62 stored in the HDD 204. In the association record newly added to the association table 62 by the table update unit 55, the version number and the operation mode included therein indicate a known version number and a known operation mode.

In a case where the update command unit 56 receives the update command from the determination unit 54, the update command unit 56 commands the MET 100 to perform update in order to cause the MET 100 to support the unknown version. More specifically, update command unit 56 controls the communication unit 205 in accordance with input of the update command from the determination unit 54, and transmits the update program, which is stored in the HDD 204 in advance, to the MET 100. The update program is a program for updating the operation of the MET 100 to support a new version of the OS program 61, and is stored in the HDD 204 in association with the temporary operation mode. When the communication I/F unit 112 of the MFP 100 receives the update program, the CPU 111 provided in the MFP 100 executes the received update program, so that the CPU 111 changes an operation to be executed in accordance with data or a command thereafter received from the outside.

The operation reception unit 57 receives an operation performed by the user. In a case where the user operates the operation unit 207 and inputs a version number corresponding to a new version and an operation mode supporting the new version, the operation reception unit 57 receives the version number and the operation mode, which are input by the user, as the operation information, and outputs the operation information to the table update unit 55. The table update unit 55 generates an association record including the version number and the operation mode supporting the new version included in the operation information in accordance with input of the operation information from the operation reception unit 57, and adds the association record to the association table 62 stored in the HDD 204. In this case, in a case where the user uses the operation unit 207 to input programs or data with which the CPU 201 executes processing corresponding to the operation content in the operation mode supporting the new version, the table update unit 55 associates the programs or data received from the operation reception unit 57 with the new operation mode, and stores the programs or data and the new operation mode to the HDD 204. It should be noted that the operation mode corresponding to the new version and the programs or data with which the CPU 201 executes processing corresponding to the operation content in the operation mode may be stored to a storage medium such as a CD-ROM 209A and the like. In this case, when the user loads the CD-ROM 209A storing the program or data to the external storage apparatus 209, and inputs an operation for commanding reading of the CD-ROM 209A into the operation unit 207, the table update unit 55 obtains the program or the data and the operation mode stored in the CD-ROM 209A via the external storage apparatus 209, and associates the program or the data and the new operation mode, which have been obtained, and stores the program or the data and the new operation mode to the HDD 204.

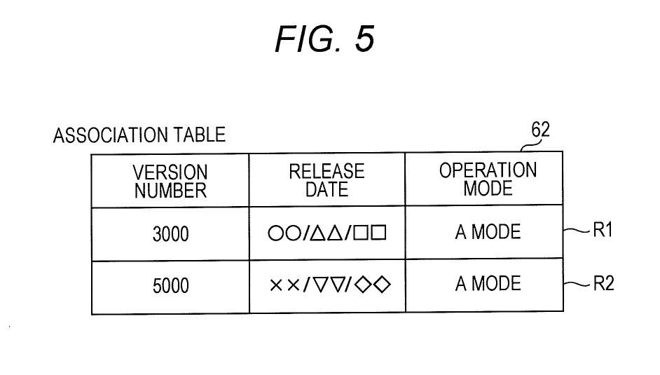

FIG. 5 is a figure showing an example of the association table 62. The association table 62 of FIG. 5 includes an association record associating a known version number, a release date of the known version, and a known operation mode. The association table 62 of FIG. 5 includes an association record R1 associating a version number “3000”, a release date “◯◯/ΔΔ/□□”, and an operation mode “A mode”, and an association record R2 associating a version number “5000”, a release date “xx/∇∇/⋄⋄”, and an operation mode “B mode”.

It should be noted that the external apparatus control unit 51, which is the task executing the printer driver program, may have the functions of the determination unit 54, the table update unit 55, the update command unit 56, the operation reception unit 57, and the identification information obtaining unit 53.

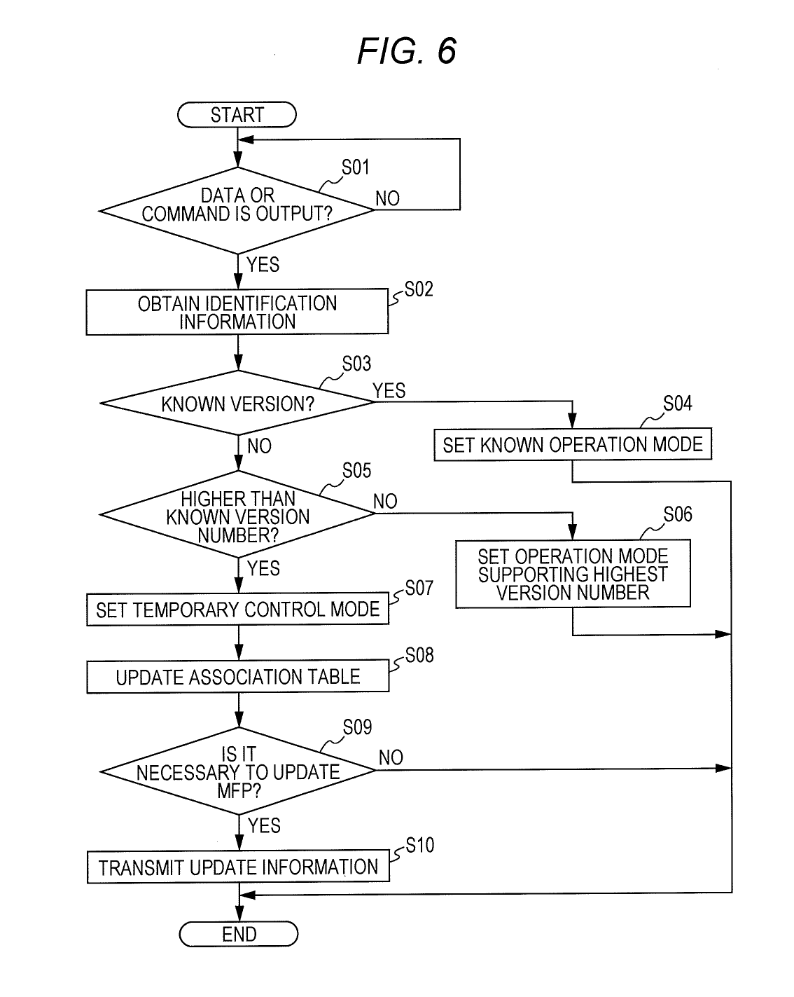

FIG. 6 is a flowchart showing an example of a flow of operation update processing according to the first embodiment. The operation update processing is processing in which the CPU 201 provided in the PC 200 executes a program stored in the ROM 202, the HDD 204, or the CD-ROM 209A, so that the CPU 201 executes the program.

As shown in FIG. 6, the CPU 201 determines whether the task which belongs to the OS layer or the application layer has output data or command (step S01). For example, the user operates the operation unit 207 to command printing, so that the task which belongs to the OS layer or the application layer outputs data or a command. The CPU 201 is in the waiting state until the task which belongs to the OS layer or the application layer outputs data or a command (No in step S01), and when the task which belongs to the OS layer or the application layer outputs data or a command (Yes in step S01), the processing is caused to proceed to step S02.

In step S02, the CPU 201 obtains identification information for identifying the current version of the OS program 61, and the processing is caused to proceed to step S03. In step S03, the CPU 201 determines whether the current version is a known version on the basis of the identification information obtained in step S02. More specifically, an association record including the same version number as the version number included in the identification information obtained in step S02 is included in the association table 62 stored in the HDD 204, the CPU 201 determines that the current version is a known version. In a case where the current version is a known version, the processing is caused to proceed to step S04, and if not, the processing is caused to proceed to step S05.

In step S04, the CPU 201 refers to the association table 62 stored in the HDD 204 to set the operation mode to an operation mode supporting the current version, and terminates the processing. For example, in a case where the CPU 201 refers to the association table 62 of FIG. 5 to find that the version number included in the identification information is “3000”, the operation mode of the MFP 100 is set to “A mode”, and in a case where the version number included in the identification information obtained is “5000”, the operation mode of the MFP 100 is set to “B mode”.

In step S05, the CPU 201 determines whether the version number corresponding to the current version is higher than the known version number on the basis of the identification information obtained in step S02. More specifically, the CPU 201 refers to the association table 62 stored in the HDD 204 to compare the version number included in the identification information obtained in step S2 with the highest version number of the version numbers defined in the association records included in the association table 62. In a case where the version number corresponding to the current version is higher than the known version number, the processing is caused to proceed to step S07, and if not, the processing is caused to proceed to step S06.

In step S06, the operation mode supporting the highest version number of the known version numbers defined by the association records included in the association table 62 stored in the HDD 204 is set, and the processing is terminated. For example, in a case where the CPU 201 refers to the association table 62 in FIG. 5 to find that the version number included in the identification information is “4000”, an association record including the same version number as the version number included in the identification information is not included in the association table 62, and the version number included in the identification information is less than the highest version number of the known version numbers defined by the association records included in the association table 62. In this case, the operation mode of the MFP 100 is set to operation mode “B mode” supporting the highest version number “5000” of the known version numbers defined by the association records included in the association table 62.

In step S07, the operation mode is set to the temporary operation mode stored in the HDD 204, and the processing is caused to proceed to step S08. In step S08, the association table 62 stored in the HDD 204 is updated, and the processing is caused to proceed to step S10. More specifically, the CPU 201 generates an association record including the version number included in the identification information and the temporary operation mode, and adds the association record to the association table 62 stored in the HDD 204. For example, in a case where the version number indicated by the identification information is “7000”, an association record including the version number “7000” and the temporary operation mode is added to the association table 62.

In step S09, a determination is made as to whether it is necessary to update the operation of the MFP 100. In a case where the operation of the MFP 100 does not support control in the new operation mode, it is necessary to update the operation of the MFP 100. For example, in a case where a new command, which is different from the known operation mode, is used in the new operation mode, the MFP 100 cannot interpret the new command, and an error may occur. In such case, it is necessary to update the operation of the MFP 100. In a case where it is necessary to update the operation of the MFP 100, the processing is caused to proceed to step S10, and if not, the processing is terminated.

In step S10, the communication unit 205 is controlled to transmit the update program to the MFP 100, and then the processing is terminated. The update program is stored in the HDD 204 in association with the temporary operation mode. The update program includes, for example, a program for interpreting commands used in the new operation mode. When the communication I/F unit 112 of the MFP 100 receives the update program, the CPU 111 executes the update program, thus updating the program stored in the ROM 113 or the HDD 115. It should be noted that in a case where the MFP 100 cannot interpret data or a command used in the new operation mode, the CPU 201 may convert the data or the command into data and a command interpretable by the MFP 100 and transmit the converted data and the converted command to the MFP 100.

As described above, the PCs 200, 200A, and 200B according to the present embodiment determine whether the current version of the OS program 61 is newer than the known version, and in a case where the current version of the OS program 61 is the same as the known version, the operation mode of the printer driver is set to the known operation mode to execute processing defined in advance for the known version, and in a case where the current version of the OS program 61 is newer than the known version, the operation mode of the printer driver is set to the temporary operation mode, and processing defined in advance for the unknown version is executed. Therefore, even in a case where it is impossible to obtain update information about the printer driver from an external server, processing corresponding to the unknown version of the OS program 61 can be executed. As a result, the MFP 100 can be controlled in accordance with the update of the OS program 61. The user does not need to perform a work for updating the printer driver and the user does not have to restart the PCs 200, 200A, and 200B, so that this can reduce the burden imposed on the user and prevents the user form being interrupted during his or her business work.

The PCs 200, 200A, and 200B obtain the identification information for identifying the current version of the OS program 61, and determine whether the version number included in the identification information is higher than the version number corresponding to the known version. Therefore, whether the version of the OS program 61 is newer than the known version can be easily determined.

Since the PCs 200, 200A, and 200B store the association table 62 in which multiple known versions of the OS program 61 and the operation modes supporting the known versions are associated with each other, the PCs 200, 200A, and 200B can easily determine whether the current version of the OS program 61 is newer than the known version by referring to the association table 62. In a case where the current version of the OS program 61 is a known version, the operation mode supporting the known version can be easily identified by referring to the association table 62.

When it is necessary to update the operation of the MFP 100 in a case where the current version of the OS program 61 is newer than the known version, the PCs 200, 200A, and 200B transmit the update program to the MFP 100, and associate the MFP 100 with an unknown version. Accordingly, the MFP 100 can be associated with the OS program 61 which has been changed.

<First Modification>

In a PC 200 according to the first modification, a determination unit 54 provided in a CPU 201 is changed. In a case where an association record including a version number corresponding to the current version included in the identification information is included in the association table 62, the determination unit 54 according to the first modification determines that the current version of the OS program 61 is a known version, and outputs the known version identification information for identifying the known version to the external apparatus control unit 51.

In a case where an association record including a version number corresponding to the current version included in the identification information is not included in the association table 62, the determination unit 54 determines whether the release date of the current version is older than the release date of the known version. More specifically, the determination unit 54 refers to the association table 62 stored in the HDD 204 to determine whether the release date of the current version included in the identification information is later than the latest release date of the release dates defined in the association records included in the association table 62. In a case where the release date included in the identification information is earlier than the latest release date of the release dates defined in the association records included in the association table 62, the determination unit 54 determines that the current version of the OS program 61 is a known version, and outputs the known version identification information for identifying the known version to the external apparatus control unit 51. The known version identification information referred to herein is the highest version number of the known version numbers defined by the association records included in the association table 62.

In a case where the release date included in the identification information is later than the latest release date of the release dates defined in the association records included in the association table 62, the determination unit 54 determines that the current version of the OS program 61 is newer than the known version, and outputs the update command to the external apparatus control unit 51, the update command unit 56, and the table update unit 55.

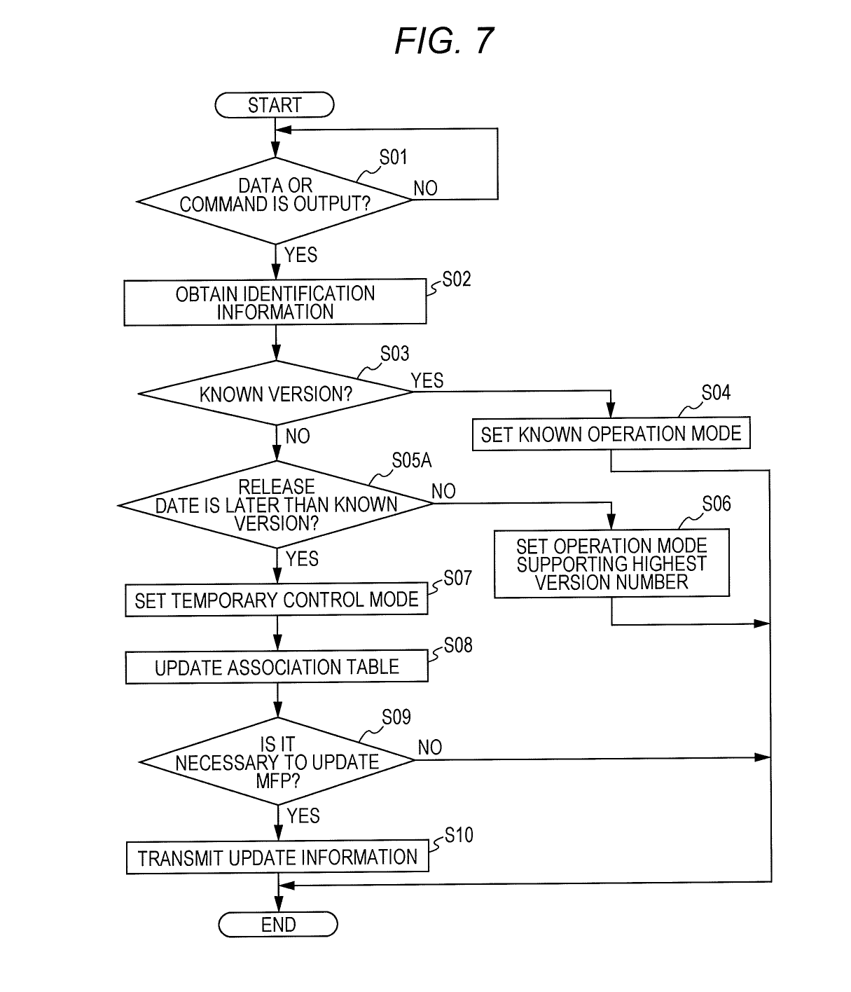

FIG. 7 is a flowchart showing an example of a flow of operation update processing according to the first modification. As shown in FIG. 7, the operation update processing according to the first modification is different from the processing shown in FIG. 6 in that step S05 is changed to step S05A. The processing other than the above is the same as the processing shown in FIG. 7, and therefore, such processing will not be explained again.

In step S05A, the CPU 201 determines whether the release date of the current version is later than the release date of the known version on the basis of the identification information obtained in step S2. More specifically, the CPU 201 refers to the association table stored in the HDD 204 to compare the release date included in the identification information obtained in step S2 with the latest release date of the release dates defined by the association records included in the association table. In a case where the release date of the current version is later than the release date of the known version, the processing is caused to proceed to step S07, and if not, the processing is caused to proceed to step S06.

As described above, the PCs 200, 200A, and 200B according to the first modification determine whether the release date included in the identification information thus obtained is later than the release date of the known version. Therefore, whether the version of the OS program 61 is newer than the known version can be easily determined, and the MFP 100 can be controlled in accordance with the update of the OS program 61.

<Second Modification>

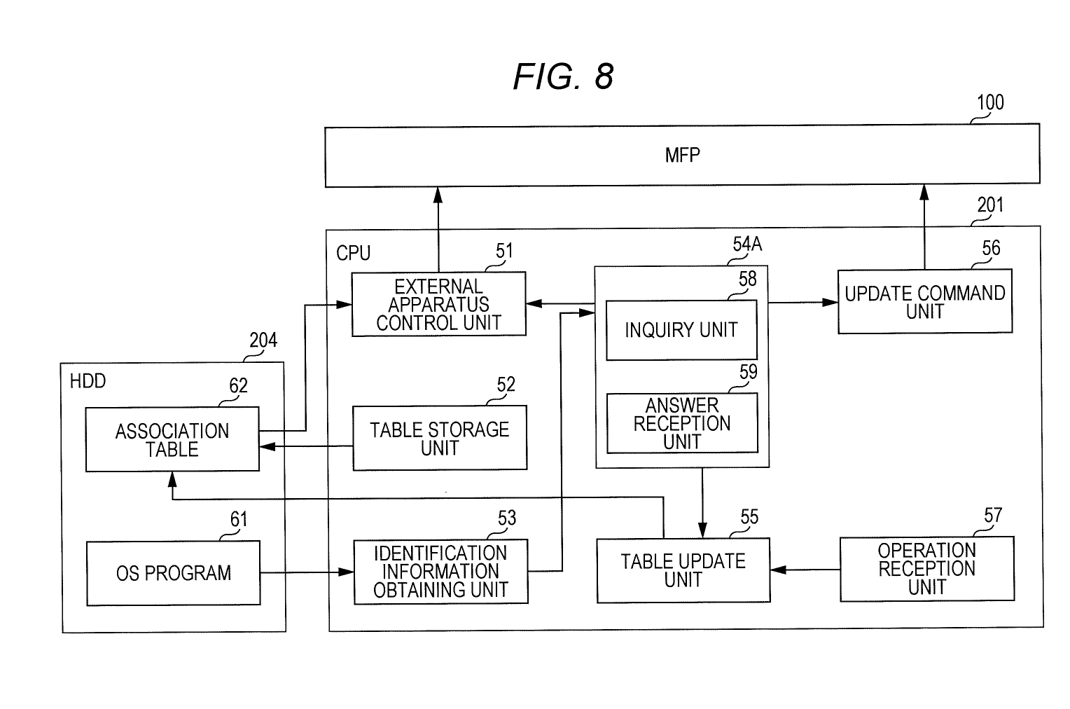

FIG. 8 is a block diagram showing an example of the functions of a CPU 201 provided in a PC 200 according to the second modification. As shown in FIG. 8, the functions of the CPU 201 according to the second modification are different from the functions as shown in FIG. 4 in that the determination unit 54 is changed to a determination unit 54A. The determination unit 54A includes an inquiry unit 58 and an answer reception unit 59.

The inquiry unit 58 determines whether the current version of the OS program 61 is a known version on the basis of the identification information received from the identification information obtaining unit 53. In a case where the current version of the OS program 61 is a known version, the inquiry unit 58 outputs the known version identification information to the external apparatus control unit 51, and in a case where the current version of the OS program 61 is not the known version, the user is asked as to whether the current version of the OS program 61 is an unknown version defined in advance. For example, the inquiry unit 58 generates an inquiry screen and displays the inquiry screen on the display unit 206. The inquiry screen includes, for example, a character string “is the version of the operation program XXX?”, a “Yes” button, and a “No” button. When the inquiry screen is displayed, the user operates the operation unit 207 to answer as to whether the current version of the OS program 61 is an unknown version defined in advance. More specifically, in a case where the current version of the OS program 61 is an unknown version defined in advance, the user operates the operation unit 207 to select the “Yes” button on the inquiry screen, and in a case where the current version of the OS program 61 is different from an unknown version defined in advance, the user operates the operation unit 207 to select the “No” button on the inquiry screen.

The answer reception unit 59 receives an answer from the user in reply to the inquiry. In a case where the answer reception unit 59 receives an answer indicating that the current version of the OS program 61 is an unknown version defined in advance, the answer reception unit 59 outputs the update command to the external apparatus control unit 51, the update command unit 56, and the table update unit 55.

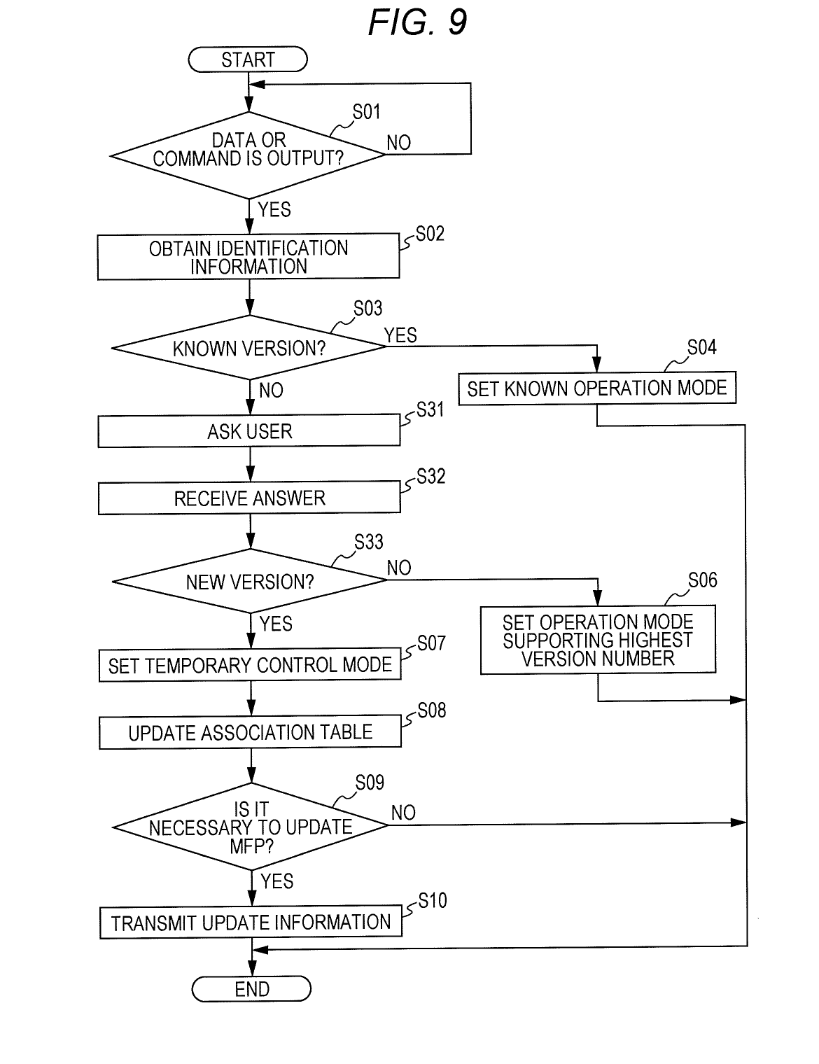

FIG. 9 is a flowchart showing an example of a flow of operation update processing according to the second modification. As shown in FIG. 9, the operation update processing according to the second modification is different from the processing as shown in FIG. 6 in that step S05 is changed to step S31, step S32, and step S33. The processing other than the above is the same as the processing shown in FIG. 6, and therefore, such processing will not be explained again.

In step S31, the CPU 201 asks the user as to whether the current version of the OS program 61 is an unknown version defined in advance, and the processing is caused to proceed to step S32. For example, an inquiry screen is generated and displayed on the display unit 206.

In step S32, an answer from the user in reply to the inquiry is received, and the processing is caused to proceed to step S33. In step S33, a determination is made as to whether the answer received in step S32 is an answer indicating that the current version of the OS program 61 is an unknown version defined in advance. In a case where an answer indicating that the current version of the OS program 61 is an unknown version defined in advance is received, the processing is caused to proceed to step S08, and if not, the processing is caused to proceed to step S06.

As described above, the PCs 200, 200A, and 200B according to the second modification determine whether the current version of the OS program 61 is new in accordance with the user's answer, and therefore, whether the version of the processing program is newer than the known version can be reliably determined, and the MFP 100 can be controlled in accordance with the update of the OS program 61.

### Second Embodiment

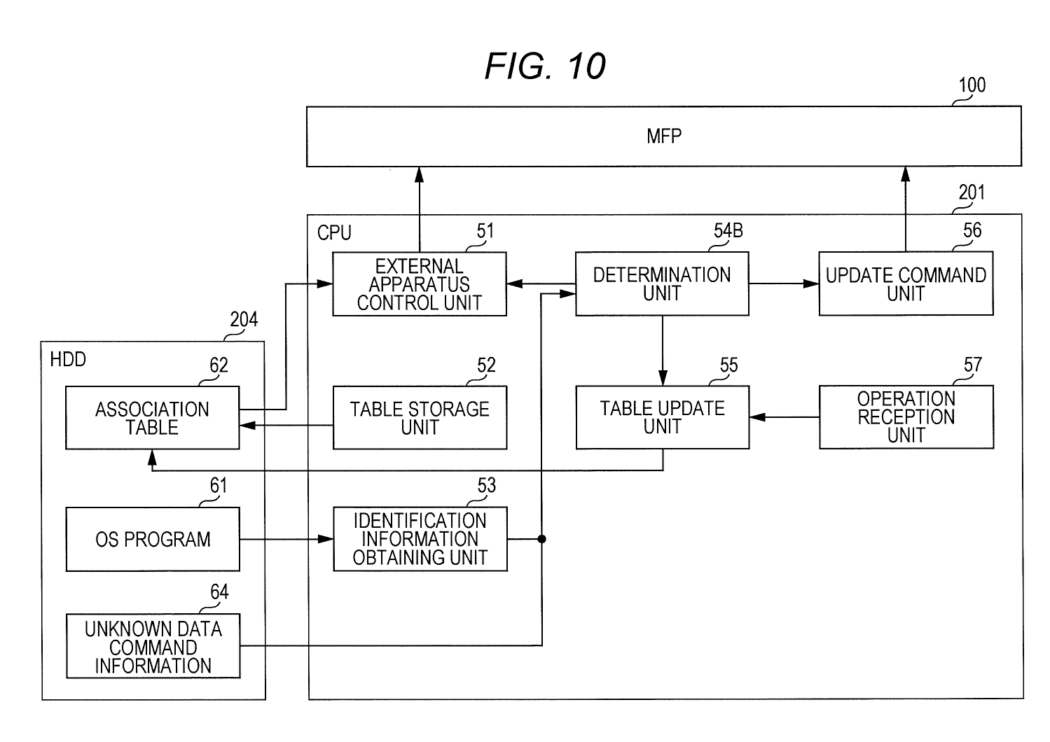

FIG. 10 is a block diagram showing an example of the functions of a CPU 201 provided in a PC 200 according to the second embodiment. As shown in FIG. 10, the functions of the CPU 201 according to the second embodiment are different from the functions shown in FIG. 4 in that the determination unit 54 is changed to a determination unit 54B.

When the version of the OS program 61 is different, a command or a format of data output from the task which belongs to the OS layer or the application layer may be different. Data output from the task which belongs to the OS layer or the application layer is, for example, data generated when the CPU 201 executes various kinds of programs. The command output from the task which belongs to the OS layer or the application layer is, for example, a print command for commanding the MFP 200 to perform printing. Examples of print commands include PJL (Print Job Language), PCL (Printer Control Language), XPS (XML Paper Specification) PrintTicket, and PS (PostScript).

The determination unit 54B according to the second embodiment determines whether the current version of the OS program 61 is a known version on the basis of the identification information received from the identification information obtaining unit 53, and in a case where the current version of the OS program 61 is a known version, the determination unit 54B outputs the known version identification information to the external apparatus control unit 51. In a case where the current version of the OS program 61 is not a known version, the determination unit 54B determines whether the current version of the OS program 61 is newer than the known version on the basis of a command or a format of data output from the task which belongs to the OS layer or the application layer. In this case, a command and a data format supporting the unknown version of the OS program 61 are stored in advance in the HDD 204 as the unknown data command information 64. The command and the data format supporting the unknown version of the OS program 61 may be notified in advance from the supplier of the OS program 61 to prepare for the release of the version. In a case where a command or a format of data output from the task which belongs to the OS layer or the application layer is included in the unknown data command information 64 stored in the HDD 204, the determination unit 54B determines that the current version of the OS program 61 is newer than the known version, and outputs the update command to the external apparatus control unit 51, the update command unit 56, and the table update unit 55.

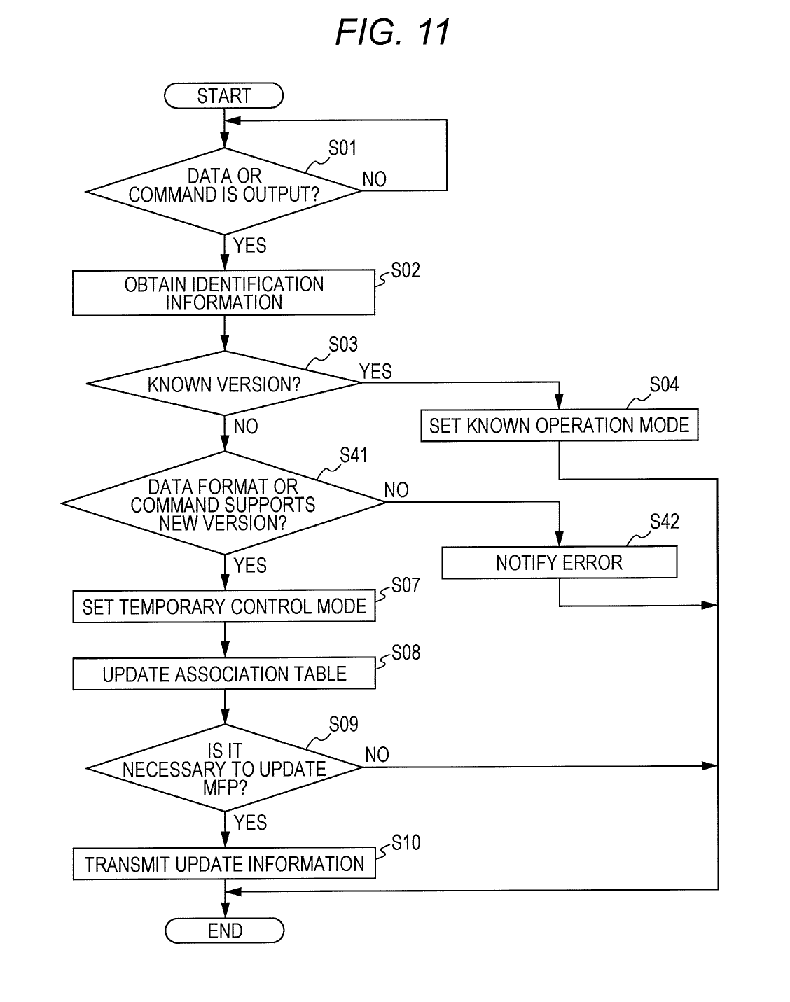

FIG. 11 is a flowchart showing an example of a flow of operation update processing according to the second embodiment. As shown in FIG. 11, the operation update processing according to the second embodiment is different from the processing as shown in FIG. 6 in that step S05 and step S06 are changed to step S41 and step S42. The processing other than the above is the same as the processing shown in FIG. 6, and therefore, such processing will not be explained again.

In step S41, a determination is made as to whether a command or a format of data output from the task which belongs to the OS layer or the application layer supports an unknown version of the OS program 61. More specifically, a determination is made as to whether a command or a format of data output from the task which belongs to the OS layer or the application layer is included in the unknown data command information 64 stored in the HDD 204. In a case where a command or a format of data output from the task which belongs to the OS layer or the application layer is included in the unknown data command information 64 stored in the HDD 204, the processing is caused to proceed to step S08, and if not, the processing is caused to proceed to step S42.

In step S42, an error is notified to the user, and the processing is terminated. For example, an error screen including the version number included in the identification information is generated, and is displayed on the display unit 206. The user sees the version number on the error screen to find that an operation is required to set the operation mode supporting the current version. In a case where the operation mode supporting the current version is included in the association table 62 stored in the HDD 204 as the known operation mode, the known operation mode is designated. This is, for example, a case where the operation mode is the same but the version number is different. In a case where the operation mode supporting the current version is not included in the association table 62 stored in the HDD 204, the operation mode supporting the current version and the operation content of the operation mode may be input. For example, a program or data with which the CPU 201 executes processing corresponding to the operation content in the current operation mode is stored in a storage medium such as a CD-ROM 209A and the like in association with the operation mode. When the user loads the CD-ROM 209A storing the program or the data to the external storage apparatus 209 and inputs a reading command operation into the operation unit 207, the CPU 201 reads the program or the data and the operation mode from the CD-ROM 209A via the external storage apparatus 209, and executes the program or the data which has been read, so that the operation mode supporting the current version can be set. Alternatively, the program or the data may be downloaded from the computer connected to the Internet, and the CPU may execute the program or the data which has been downloaded, so that the operation mode supporting the current version is set.

As described above, the PCs 200, 200A, and 200B according to the second embodiment determine whether a command or a format of data output from the task which belongs to the OS layer or the application layer is a data format or a command defined in advance, and therefore, the version of the OS program 61 can be determined to have been changed, and the MFP 100 can be controlled in accordance with the update of the OS program 61.

### Third Embodiment

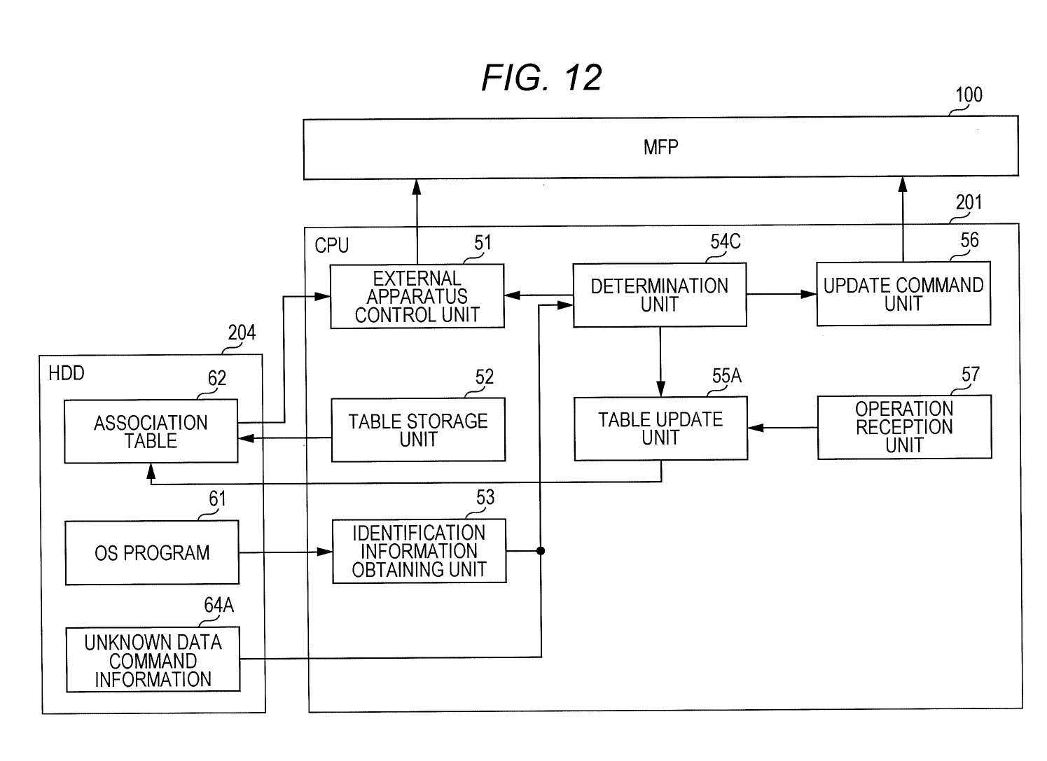

FIG. 12 is a block diagram showing an example of the functions of a CPU 201 provided in a PC 200 according to the third embodiment. As shown in FIG. 12, the functions of the CPU 201 according to the third embodiment are different from the functions as shown in FIG. 4 in that the determination unit 54 and the table update unit 55 are changed to a determination unit 54C and a table update unit 55A. The HDD 204 previously stores unknown data command information 64A and a program or data with which the CPU 201 executes processing corresponding to the operation content in an auxiliary temporary operation mode. For example, the unknown data command information 64A and the program or the data are recorded and provided in a recording medium such as a CD-ROM and the like from a serviceman who maintains the MFP 100, and are stored by the user to the HDD 204 in association with the auxiliary temporary operation mode.

The determination unit 54C according to the third embodiment determines whether the current version of the OS program 61 is newer than the known version, and determines whether the current version of the application program is newer than the known version. The application program according to the third embodiment is an example of a processing program. In this case, the determination unit 54C determines whether the version number corresponding to the current version is higher than a known version number on the basis of the identification information received from the identification information obtaining unit 53, and in a case where the version number corresponding to the current version is higher than the known version number, the determination unit 54C determines that the current version of the OS program 61 is newer than the known version. In a case where the current version of the OS program 61 is newer than the known version, the determination unit 54C outputs the update command to the external apparatus control unit 51, the update command unit 56, and the table update unit 55A. It should be noted that, like the first modification of the first embodiment, the determination unit 54C may determine that the current version is newer than the known version in a case where the release date of the current version is later than the release date of the known version. Like the second modification according to the first embodiment, the determination unit 54C may ask the user, and in a case where the determination unit 54C receives an answer indicating that the current version is newer than the known version, the determination unit 54C may determine that the current version is newer than the known version.

In a case where the current version of the OS program 61 is a known version, the determination unit 54C determines whether the current version of the application program is newer than the known version on the basis of a command or a format of data output from the task which belongs to the application layer. The current version is a version installed in the PC 200, and the CPU 201 executes the application program of the current version. In this case, a data format and a command supporting an unknown version of an application program are stored in the HDD 204 as the unknown data command information 64A. A data format and command supporting an unknown version of the application program is notified in advance from the supplier of the application program to prepare for the release of the version.

In a case where a command or a format of data output from the task which belongs to the application layer is not included in the unknown data command information 64A stored in the HDD 204, the determination unit 54C determines that the current version of the application program is a known version, and outputs the known version identification information to the external apparatus control unit 51. On the other hand, in a case where a command or a format of data output from the task which belongs to the application layer is included in the unknown data command information 64A stored in the HDD 204, the determination unit 54C determines that the current version of the application program is newer than the known version, and outputs, to the table update unit 55A, record identification information for identifying an association record which is included in the association table 62 and which includes the identification information received from the identification information obtaining unit 53.

For example, when the version of the application program is different, the items of print setting included in the UI screen that can be displayed by execution of the application program may be different. Therefore, the items of print setting to be referred to when the MFP 100 is commanded to perform printing may be different according to operation mode. When the version of the application program is different, the format of data output from the task which belongs to the application layer may be different. Therefore, the compression format of data when the data is sent to the MFP 100 may be different. Therefore, the compression format of data when the MFP 100 is commanded to perform printing may be different depending on the operation mode.

In a case where the table update unit 55A receives the update command from the determination unit 54C, the table update unit 55A generates an association record including the version number included in the update command and the temporary operation mode stored in the HDD 204, and adds the association record to the association table 62 stored in the HDD 204. In a case where the table update unit 55A receives the record identification information from the determination unit 54C, the table update unit 55A changes the known operation mode defined in the association record identified by the record identification information of the association records included in the association table 62 to the auxiliary temporary operation mode. The program or the data with which the CPU 201 executes processing corresponding to the operation content in the auxiliary temporary operation mode is provided by, for example, a serviceman who maintains the MFP 100, and stored in the HDD 204 in association with the auxiliary temporary operation mode. Therefore, the external apparatus control unit 51 operates in the auxiliary temporary operation mode, so that the external apparatus control unit 51 can execute processing corresponding to the data or the command output from the task executing the application program of the new version.

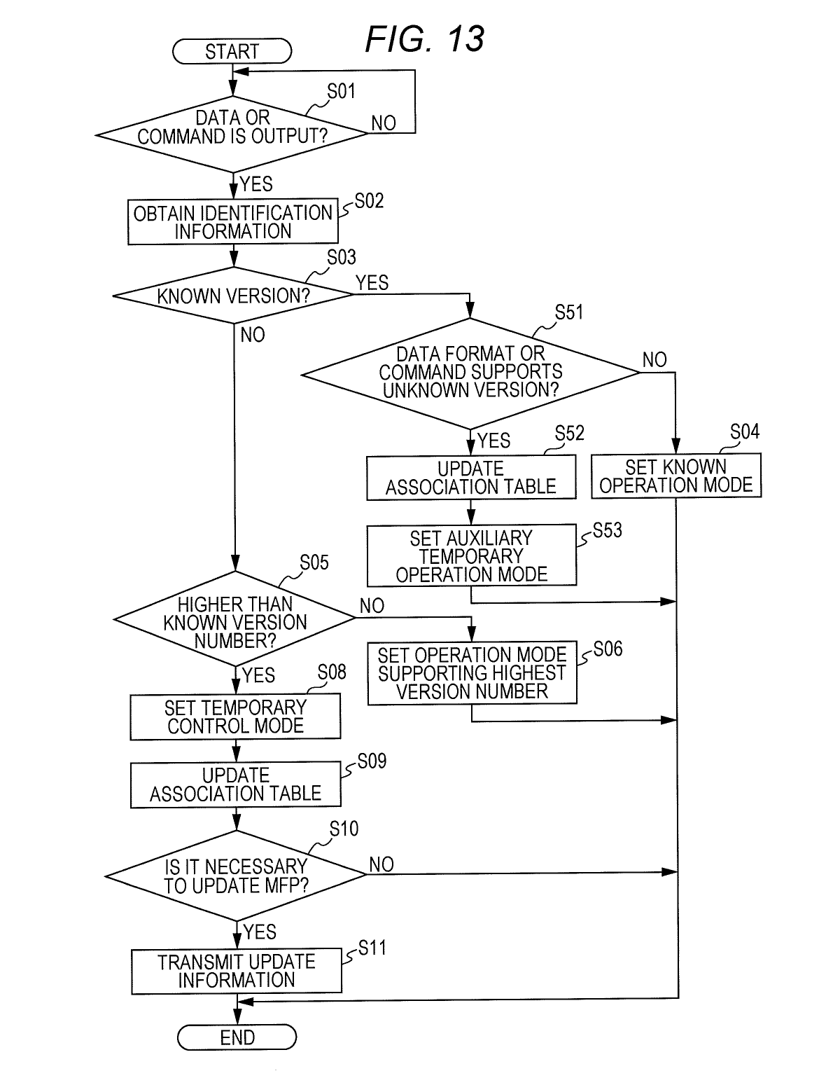

FIG. 13 is a flowchart showing an example of a flow of operation update processing according to the third embodiment. As shown in FIG. 13, the operation update processing according to the third embodiment is different from the processing as shown in FIG. 6 in that step S51, step S52, and step S53 are added as the processing performed in the case where “Yes” is selected in step S03. The processing other than the above is the same as the processing shown in FIG. 6, and therefore, such processing will not be explained again.

In step S51, the CPU 201 determines whether a command or a format of data output from the task which belongs to the application layer supports an unknown version of the application program. More specifically, in a case where a command or a format of data output from the task which belongs to the application layer is included in the unknown data command information 64A stored in the HDD 204, the command or the format is determined to support the unknown version of the application program. In a case where the command or the format of data output from the task which belongs to the application layer supports the unknown version of the application program, the processing is caused to proceed to step S53, and if not, the processing is caused to proceed to step S04.

In step S53, the association table 62 stored in the HDD 204 is updated, and the processing is caused to proceed to step S54. More specifically, the known operation mode defined in the association record including the version number included in the identification information obtained in step S02 is updated to the auxiliary temporary operation mode. In step S54, the operation mode is set to the auxiliary temporary operation mode, and the processing is terminated.

As described above, the PCs 200, 200A, and 200B according to the third embodiment determine whether the current version of the application program is newer than the known version, and in a case where the current version of the application program is newer than the known version, the operation mode of the printer driver is set to the auxiliary temporary operation mode, and the processing defined in advance for the unknown version is executed. Therefore, even in a case where update information about the printer driver cannot be obtained from the external server, processing corresponding to an unknown version of the application program can be executed. As a result, the MET 100 can be controlled in accordance with the update of the application program.

### Fourth Embodiment

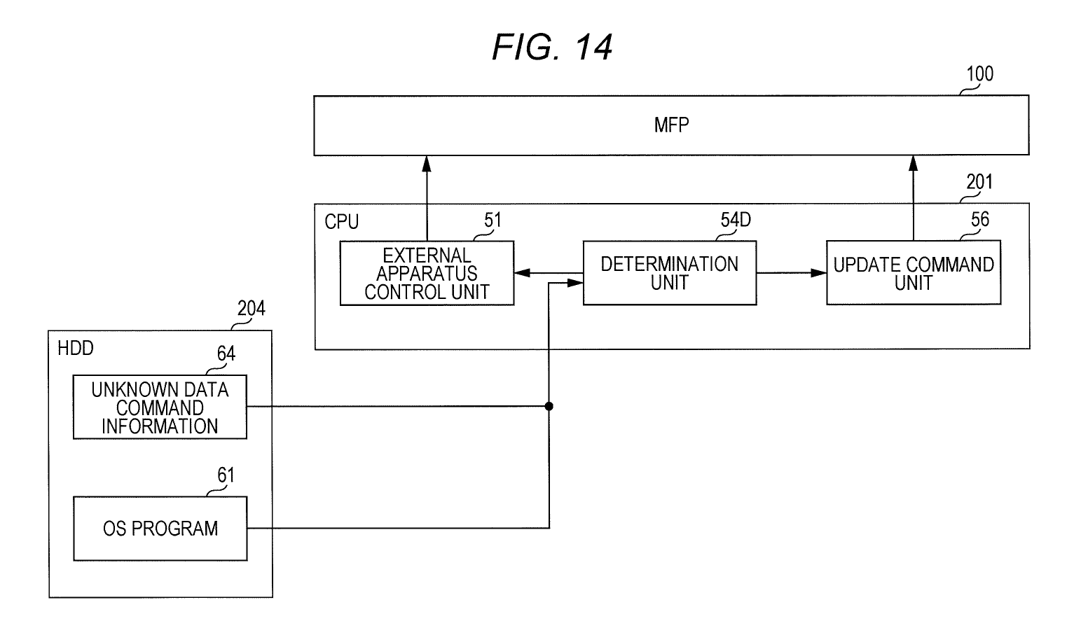

FIG. 14 is a block diagram showing an example of the functions of a CPU 201 provided in a PC 200 according to the fourth embodiment. As shown in FIG. 14, the functions of the CPU 201 according to the fourth embodiment are different from the functions as shown in FIG. 4 in that the determination unit 54 is changed to a determination unit 54D, and that the table storage unit 52, the identification information obtaining unit 53, the table update unit 55, and the operation reception unit 57 are deleted. In addition, the HDD 204 according to the fourth embodiment does not store the association table 62, and like the second embodiment, the HDD 204 according to the fourth embodiment stores the unknown data command information 64.

The determination unit 54D according to the fourth embodiment determines whether the current version of the OS program 61 is newer than the known version on the basis of a command or a format of data output from the task which belongs to the OS layer or the application layer. The OS program according to the fourth embodiment is an example of a processing program. In a case where a command or a format of data output from the task which belongs to the OS layer or the application layer is included in the unknown data command information 64 stored in the HDD 204, the determination unit 54D determines that the current version of the OS program 61 is newer than the known version, and outputs the update command to the external apparatus control unit 51 and the update command unit 56. In a case where a command or a format of data output from the task which belongs to the OS layer or the application layer is not included in the unknown data command information 64 stored in the HDD 204, the determination unit 54D determines that the current version of the OS program 61 is a known version, and maintains the operation mode as the known operation mode without outputting the update command.

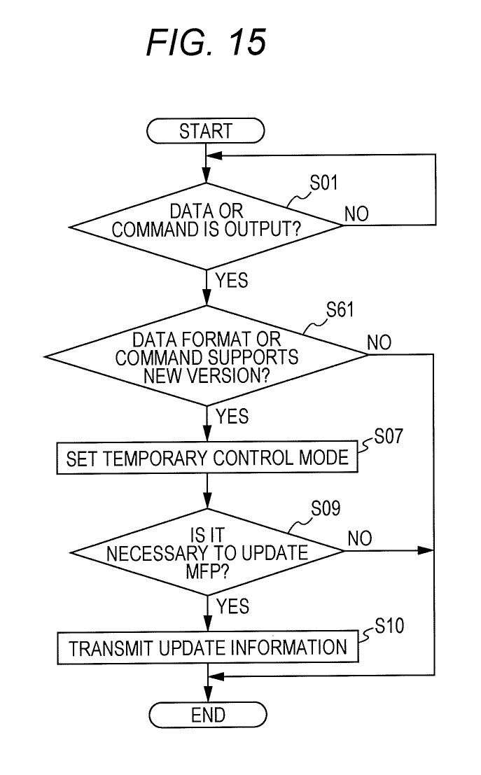

FIG. 15 is a flowchart showing an example of a flow of operation update processing according to the fourth embodiment. As shown in FIG. 15, the operation update processing according to the fourth embodiment is different from the processing as shown in FIG. 6 in that step S02, step S03, step S04, step S05, step S06, and step S08 are changed to step S61. The processing other than the above is the same as the processing shown in FIG. 6, and therefore, such processing will not be explained again.

In step S61, a determination is made as to whether a command or a format of data output from the task which belongs to the OS layer or the application layer supports an unknown version of the OS program 61. More specifically, a determination is made as to whether a command or a format of data output from the task which belongs to the OS layer or the application layer is included in the unknown data command information 64 stored in the HDD 204. In a case where a command or a format of data output from the task which belongs to the OS layer or the application layer is included in the unknown data command information 64 stored in the HDD 204, the processing is caused to proceed to step S07, and if not, the processing is terminated. Therefore, in a case where a command or a format of data output from the task which belongs to the OS layer or the application layer is included in the unknown data command information 64 stored in the HDD 204, the operation mode is switched to the temporary control mode, and in a case where the command or the format of data output from the task which belongs to the OS layer or the application layer is not included in the unknown data command information 64 stored in the HDD 204, the operation mode is maintained as the known operation mode.

As described above, the PCs 200, 200A, and 200B according to the fourth embodiment determine whether a command or a format of data output from the task which belongs to the OS layer or the application layer is a data format or a command defined in advance, and therefore, the version of the OS program 61 can be determined to have been changed, and the MFP 100 can be controlled in accordance with the update of the OS program 61.

It should be noted that the CPU 201 according to the fourth embodiment determines whether the current version of the OS program 61 is newer than the known version, and in a case where the current version of the OS program 61 is newer than the known version, the operation mode is switched to the temporary operation mode, but instead of this, a determination may be made as to whether the current version of the application program is newer than the known version, and in a case where the current version of the application program is newer than the known version, the operation mode may be switched to an operation mode defined in advance. In this case, the application program is an example of a processing program. In this case, the version of the application program can be determined to have been changed, and the MFP 100 can be controlled in accordance with the update of the application program.

In the above embodiments, the MFP 100 has been explained as an example of an external apparatus. However, the external apparatus may be a peripheral apparatus to be controlled by the PCs 200, 200A, and 200B, such as a printer or a facsimile apparatus.

In the above embodiments, the print system 1 has been explained, but it should be understood that the present invention may also be interpreted as an operation update method for causing the PCs 200, 200A, and 200B to execute the processing shown in FIG. 6, FIG. 7, FIG. 9, FIG. 11, FIG. 13, and FIG. 15 and an operation update program for causing the CPUs of the PCs 200, 200A, and 200B to execute the operation update method.

<Supplementary Note>

(1) The information processing apparatus of Items 1 to 9, wherein the external apparatus control unit includes a conversion unit converting a data and a command output from a task executing the processing program into a data and a command that can be interpreted by the external apparatus.

(2) The information processing apparatus of Item 7, further including:

an operation reception unit receiving operation performed by a user; and

a table update unit updating the association table in accordance with the received operation.

(3) The information processing apparatus of Item 7, further including:

a table storage unit storing an association table associating a version number of each of one or more processing programs and processing corresponding to a version identified by the version number; and

a table update unit updating the association table by associating a version number of an unknown version and processing defined in advance for the unknown version in a case where the version of the identification information obtained is determined to be newer than the known version.

(4) The information processing apparatus according to any one of Items 1 to 9, wherein the processing program includes an operating system program.

(5) The information processing apparatus according to any one of Items 1 to 9, wherein the external apparatus includes an image processing apparatus processing an image.

Although the present invention has been described and illustrated in detail, it is clearly understood that the same is by way of illustrated and example only and is not to be taken by way of limitation, the scope of the present invention being interpreted by terms of the appended claims. The scope of the present invention is intended to include meanings equivalent to the claims and all changes within the scope of the claims.

What is claimed is:

1. An information processing apparatus comprising:
an external apparatus control unit controlling an external apparatus in accordance with data output from a task executing a processing program defining processing for outputting data to be processed by the external apparatus; and
a determination unit determining whether a version of the processing program is newer than a known version,
wherein in a case where the version of the processing program is determined to be the same as the known version, the external apparatus control unit executes processing defined in advance for the known version, and in a case where the version of the processing program is determined to be newer than the known version, the external apparatus control unit executes processing defined in advance for the unknown version.

2. The information processing apparatus according to claim 1, further comprising an identification information obtaining unit obtaining identification information identifying the version of the processing program,
wherein the determination unit determines whether the version indicated by the obtained identification information is newer than the known version.

3. The information processing apparatus according to claim 2, wherein the identification information includes a version number corresponding to the version, and
the determination unit determines whether the version number included in the identification information obtained is higher than a version number corresponding to the known version.

4. The information processing apparatus according to claim 2, wherein the identification information includes a release date of the version of the processing program, and
the determination unit determines whether the release date included in the identification information is later than the release date of the known version.

5. The information processing apparatus according to claim 1, wherein the determination unit determines whether a format of data output from a task executing the processing program is a format defined in advance.

6. The information processing apparatus according to claim 1, wherein the determination unit determines whether a command output from a task executing the processing program is a command defined in advance.

7. The information processing apparatus according to claim 1, further comprising a table storage unit storing an association table associating one or more known versions of the processing program and processing supporting the known versions,
wherein the determination unit determines whether the version of the processing program is newer than the version included in the association table.

8. The information processing apparatus according to claim 1, wherein the determination unit includes:
an inquiry unit asking a user of an inquiry as to whether the version of the processing program is newer than the known version; and
an answer reception unit receiving an answer in reply to the inquiry.

9. The information processing apparatus according to claim 1, further comprising an update command unit commanding the external apparatus to perform update in order to cause the external apparatus to support the unknown version in a case where the version of the processing program is determined to be newer than the known version.

10. An operation update method executed by an information processing apparatus including an external apparatus control unit controlling an external apparatus in accordance with data output from a task executing a processing program defining processing for outputting data to be processed by the external apparatus, the method comprising:
a determination step of determining whether a version of the processing program is newer than a known version; and
a processing execution step of causing the external apparatus control unit to execute processing defined in advance for the known version in a case where the version of the processing program is determined to be the same as the known version, and causing the external apparatus control unit to execute processing defined in advance for the unknown version in a case where the version of the processing program is determined to be newer than the known version.

11. A non-transitory recording medium storing a computer readable operation update program executed by a computer controlling an information processing apparatus including an external apparatus control unit controlling an external apparatus in accordance with data output from a task executing a processing program defining processing for outputting data to be processed by the external apparatus, the program causing the computer to execute:
a determination step of determining whether a version of the processing program is newer than a known version; and
a processing execution step of causing the external apparatus control unit to execute processing defined in advance for the known version in a case where the version of the processing program is determined to be the same as the known version, and causing the external apparatus control unit to execute processing defined in advance for the unknown version in a case where the version of the processing program is determined to be newer than the known version.
